(19) United States
(12) Patent Application Publication
(10) Pub. No.: US 2025/0329968 A1
(43) Pub. Date: Oct. 23, 2025

(54) GenSet Power Flowthru Splitter

(71) Applicant: Miron Trache, Melville, NY (US)

(72) Inventor: Miron Trache, Melville, NY (US)

(21) Appl. No.: 18/643,140

(22) Filed: Apr. 23, 2024

(51) Int. Cl. H01R 13/713; H01R 13/52; H01R 13/717

(52) U.S. Cl. CPC H01R 13/7135; H01R 13/5202; H01R 13/7175

(57) ABSTRACT

A power splitter designed for use on a construction site wherein the power draw on a particular electrical line may be determined when in use. The GCFI outlet breaker does not prevent the other phases of power from passing through the flowthru splitter, workers at a one workstation can continue working even if there is a tool malfunction at another. The power splitter also allows the circuit breaker to be reset at the power splitter as opposed to the breaker panel.

### CROSS-REFERENCE TO RELATED APPLICATIONS

This application does not have any related applications.

### BACKGROUND OF THE INVENTION

When renovating skyscrapers, it is common to use a suspended scaffold, generally powered from an electrical panel on the roof of the building. These scaffolds on use power to move the platform up and down, usually with either one or two single phase or three phase motors. The use of a common power source for both the scaffold and the tools used for renovation or repair of the facade can easily trip a circuit breaker, leaving workers stranded until someone resets the circuit breaker or they use the emergency brakes to lower the scaffold.

Existing workarounds to prevent this include using stepdown transformers and running multiple power lines to a single scaffold. Each of these increases costs. Most power tools use 13 amps or more, and a total limit for a rig of 30 amps means that one or two men can work at most without additional power lines.

### SUMMARY OF THE INVENTION

A “smart” power cord and outlet, which provides power in a single phase to a single workstation and passes power through to provide power in a different single phase to the next workstation, limiting the total power use and reducing the likelihood of tripping a circuit breaker.

### BRIEF DESCRIPTION OF DRAWINGS

FIG. 1 shows a perspective view of the Genset Flowthru Splitter.

### DETAILED DESCRIPTION OF THE INVENTION

In the following description, numerous specific details are set forth to clearly describe the embodiments disclosed herein. However, one skilled in the art will understand that some well known features have not been described in detail so as not to obscure the invention.

In the following description, like reference numbers are used to identify like elements. Furthermore, the drawings are intended to illustrate major features of the exemplary embodiments in a diagrammatic manner. The drawings are not intended to depict every feature of every implementation and are not drawn to scale.

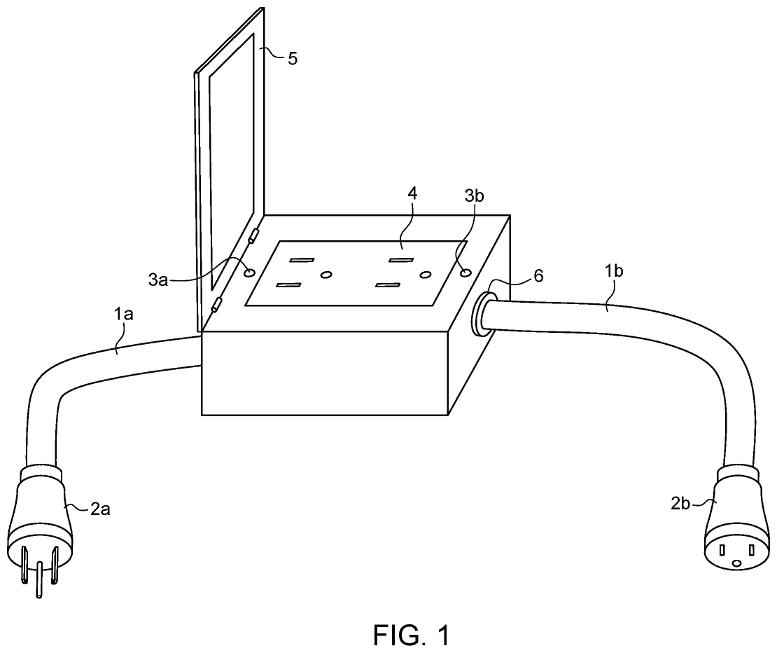

As shown in FIG. 1, the genset flowthru splitter has a first end and a second end. The first end and second end each have an R6-20 NEMA plug (2a) and an LED (3a, 3b), used to indicate whether or not a given line is in use. The LEDs are mounted within the power plugs for each line.

Between the first end and second end is a single phase 20 amp GCFI outlet (4). The GCFI outlet breaker will trip if the power used exceeds what is permitted by the GCFI for that line, preventing the main breaker from tripping. Because GCFI outlets also include the switch to reset the outlet, this lets the workers reset the outlet, instead of requiring someone on the roof to reset the whole thing at the breaker panel.

The cable (1a, 1b) between the plugs (2a, 2b) and the GCFI outlet (4) is 104SO electric cable, which carries a maximum of 30 amps and may carry single phase or three phase power. The Genset Flowthru Splitter is constructed so that a single phase of power is used for each line. Three phase power is taken from the generator or building power source. One phase or two phases are used to power the scaffold motor(s), depending upon the particular equipment used. One phase is available via the GCFI outlet for workers at a first workstation. In projects with multiple workstations, the third phase is available via the second GCFI outlet for workers at the second workstation.

The Genset Flowthru Splitter is a smart device that uses molded power plugs and is generally constructed of materials suitable for outdoor use, which includes exposure to sunlight and weather. The GCFI outlet has a cover (4) and seal (5), to protect the outlet itself from the weather. The outlet box is also connected to the cable with a waterproof connector (6) at each end. Because they are modularly constructed, it is easy to determine which part or section of the Genset Flowthru Splitter needs to be repaired or replaced.

Because tripping the GCFI outlet breaker does not prevent the other phases of power from passing through the flowthru splitter, workers at a one workstation can continue working even if there is a tool malfunction at another.

While illustrative embodiments of the invention have been shown and described, variations and alternative embodiments will occur to those skilled in the art. Such variations and alternative embodiments can be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

1. A power splitter comprising of a male plug, a female plug, two LEDs, electric cable, waterproof connector, a seal, and a GCFI outlet.

2. The power splitter as in claim 1, wherein the LEDs indicate whether the electrical line is in use.

3. The power splitter as in claim 1, wherein the GCFI outlet will trigger the internal circuit breaker if electrical usage exceeds the threshold, preventing the need to reset the breaker at the breaker panel.

4. The power splitter as in claim 1, wherein the seal is rotatably affixed to the power splitter so as to protect the GCFI outlet when not in use.

5. The power splitter as in claim 1, wherein the waterproof connector is affixed to the electric cable and GCFI outlet.

6. A method of manufacturing a power splitter comprising of a male plug, a female plug, two LEDs, electric cable, waterproof connector, a seal, and a GCFI outlet.

7. The method of manufacturing the power splitter as in claim 6, wherein the LEDs indicate whether the electrical line is in use.

8. The method of manufacturing the power splitter as in claim 6, wherein the GCFI outlet will trigger the internal circuit breaker if electrical usage exceeds the threshold, preventing the need to reset the breaker at the breaker panel.

9. The method of manufacturing the power splitter as in claim 6, wherein the seal is rotatably affixed to the power splitter so as to protect the GCFI outlet when not in use.

10. The method of manufacturing the power splitter as in claim 6, wherein the waterproof connector is affixed to the electric cable and GCFI outlet.
